(19) United States
(12) Patent Application Publication
(10) Pub. No.: US 2026/0141707 A1
(43) Pub. Date: May 21, 2026

(54) CONVOLUTIONAL NEURON NETWORK FOR LITHOLOGY FACIES CLASSIFICATION

(71) Applicant: Schlumberger Technology Corporation, Sugar Land, TX (US)

(72) Inventors: Weijia Du, Cambridge (GB); Mustafa Al Hussain, Dhahran (SA); Merza Media Adeyosfi, Dhahran (SA); Abdullah Yaseen Albuali, Dhahran (SA); Mustafa Ahmad Al Mubarak, Dhahran (SA)

(21) Appl. No.: 19/243,114

(22) Filed: Jun. 19, 2025

Related U.S. Application Data
(60) Provisional application No. 63/720,782, filed on Nov. 15, 2024.

(51) Int. Cl. G06V 10/82; E21B 47/002; E21B 49/00; G06V 10/24; G06V 10/26; G06V 10/764; G06V 20/50

(52) U.S. Cl. CPC G06V 10/82; E21B 47/0025; E21B 49/00; G06V 10/24; G06V 10/26; G06V 10/764; G06V 20/50; E21B 2200/20

(57) ABSTRACT

A method for classifying lithology facies includes receiving a processed and interpreted borehole image. The method also includes receiving an openhole log. The method also includes pre-processing the borehole image to produce a pre-processed borehole image. The method also includes pre-processing the openhole log to produce a pre-processed openhole log. The method also includes modeling the pre-processed borehole image and the pre-processed openhole log to produce a first modelled output and a second modelled output, respectively. The method also includes concatenating the first modelled output and the second modelled output from first and second heads of the convolutional neuron network to produce a concatenated output. The method also includes passing the concatenated output through a softmax layer. The method also includes classifying lithology facies in the subsurface formation based at least partially upon an output of the softmax layer.

### CROSS-REFERENCE TO RELATED APPLICATIONS

This application claims priority to U.S. Provisional Patent Application No. 63/720,782, filed on Nov. 15, 2024, which is incorporated by reference in its entirety.

### BACKGROUND

Facies is a distinctive classification of a subsurface formation that can be distinguished from adjacent bodies of rock and sediment. Facies interpretation is used in formation characterization to understand the geological depositional system, the reservoir quality, and the potential hazards during production and drilling.

Conventionally, facies are defined manually by a geologist combining multiple data inputs such as open hole logs, mud log, drilling parameters, borehole image log, and core data. This process is repetitive and thus takes a long time because the interpreter analyses and interprets the facies depth by depth. Bias and inconsistencies may result due to interpreter experience and subjectivity. Therefore, what is needed is an objective and faster facies definition for operational support, which may serve as the baseline for the next reservoir characterization step.

### SUMMARY

A method for classifying lithology facies is disclosed. The method includes receiving a borehole image. The method also includes receiving an openhole log. The method also includes modeling the borehole image to produce a first modelled output. The method also includes modeling the openhole log to produce a second modelled output. The method also includes concatenating the first modelled output and the second modelled output to produce a concatenated output. The method also includes classifying the lithology facies in a subsurface formation based at least partially upon the concatenated output.

In another embodiment, the method includes receiving a processed and interpreted borehole image. The borehole image shows a texture of a subsurface formation and resistivity properties in the subsurface formation. The borehole image is captured during logging in a wellbore in the subsurface formation by a downhole tool with a plurality of arms and a plurality of electrodes. The method also includes receiving an openhole log. The openhole log includes triple combo and spectroscopy data. The openhole log is configured to be used to define a lithology of one or more intervals in the subsurface formation. The method also includes pre-processing the borehole image to produce a pre-processed borehole image. Pre-processing the borehole image includes vertically aligning columns in the borehole image. Vertically aligning the columns comprises reducing a number of the columns in the borehole image. The number is reduced from a number of the arms plus one down to the number of arms. Pre-processing the borehole image also includes filling missing values inside the columns using interpolation. Pre-processing the borehole image also includes cutting the columns by width and by depth into first square chunks. Each first square chunk has a width that has a same number of pixels as a width of each of the columns, and each first square chunk has a depth that has a same number of pixels as the depth of each of the columns. Pre-processing the borehole image also includes arranging the first square chunks such that a number of layers corresponds to a number of the columns, which causes a shape of the pre-processed borehole image to be 50*50*4. The method also includes pre-processing the openhole log to produce a pre-processed openhole log. Pre-processing the openhole log includes concatenating the openhole log into an image shape. Pre-processing the openhole log also includes cutting the image shape into second square chunks. Each second square chunk has a width that has a same number of pixels as the width of each of the columns, and each second square chunk has a depth that has a same number of pixels as the depth of each of the columns such that a shape of the pre-processed openhole log is 50*10*1. The method also includes modeling the pre-processed borehole image and the pre-processed openhole log to produce a first modelled output and a second modelled output, respectively. The pre-processed borehole image is modelled using a first head of a convolutional neuron network. The pre-processed openhole log is modelled using a second head of the convolutional neuron network. Modeling the pre-processed borehole image and/or the pre-processed openhole log includes passing the pre-processed borehole image and/or the pre-processed openhole log through a convolutional layer of the convolutional neuron network to produce a convolutional layer output. The modeling also includes passing the convolutional layer output through a batch normalization layer of the convolutional neuron network to produce a batch normalization layer output. The modeling also includes passing the batch normalization layer output through a regular linear unit layer of the convolutional neuron network to produce a regular linear unit layer output. The modeling also includes aggregating the regular linear unit layer output from an average pooling layer of the convolutional neuron network to produce the first modelled output and/or the second modelled output. The method also includes concatenating the first modelled output and the second modelled output from the first and second heads of the convolutional neuron network to produce a concatenated output. The concatenated output is a 1D series. The method also includes passing the concatenated output through a softmax layer. The method also includes classifying lithology facies in the subsurface formation based at least partially upon an output of the softmax layer. The method also includes displaying the classified lithology facies.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a borehole image log showing a vuggy carbonate interval, according to an embodiment.

FIGS. 3A and 3B illustrate two borehole chunk images corresponding to the original image (FIG. 3A) and the pre-processed image (FIG. 3B) by correcting the rotation and filling the gaps inside of the columns, according to an embodiment.

FIG. 4 illustrates a schematic view of the architecture of the convolutional neuron network, according to an embodiment.

FIG. 5 illustrates a convolutional layer, according to an embodiment.

FIG. 6 illustrates a flowchart of a method for classifying lithology facies, according to an embodiment.

FIGS. 7A-7F illustrate images of classified lithology facies, according to an embodiment.

FIG. 8 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

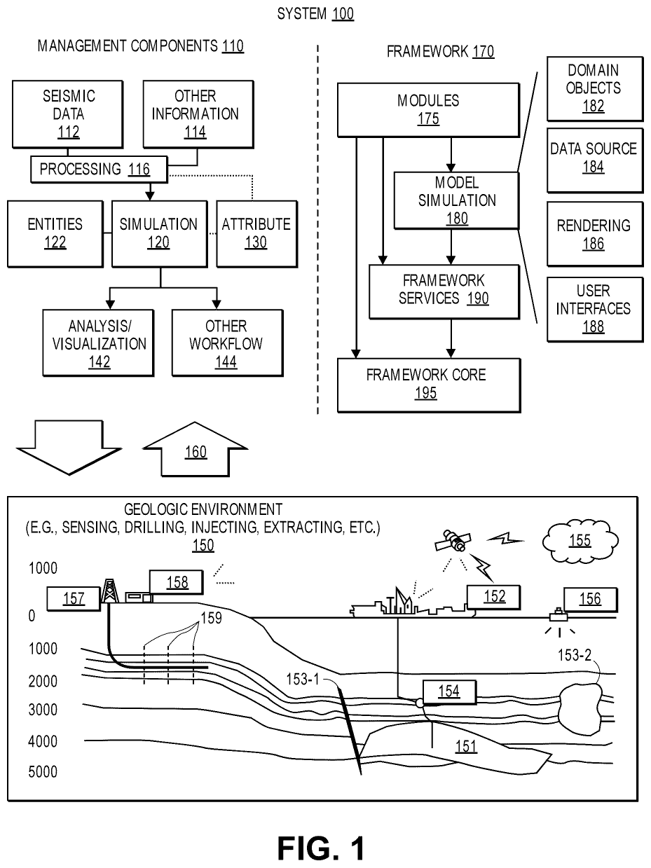

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Convolutional Neuron Network for Lithology Facies Classification

The present disclosure includes a convolutional neuron network approach for classifying geology facies such as anhydrite, bedded coarse grain limestone, bedded dolostone, bedded limestone, deformed dolostone, laminated shale, massive coarse grain limestone, massive dolostone, massive limestone, massive shale, nodular limestone, shoal deposit dolostone, shoal deposit limestone, stylolitic limestone, vuggy dolostone, vuggy limestone, or a combination thereof. The convolutional neuron network may include a two-headed architecture with one head taking pre-processed borehole images and the other head taking the signals. This improves accuracy on the borehole facies classification.

In one example, the method described herein may be used to analyze facies in a carbonate reservoir with a borehole image log as input for textural analysis. The facies label that is created by this workflow is a lithological type and texture. The lithological type is defined based on the borehole image and signal input (e.g., an open hole log), and the textural is based on the borehole image log. For example, “laminated shale” is a shale lithology with laminated texture.

### Borehole Image Description

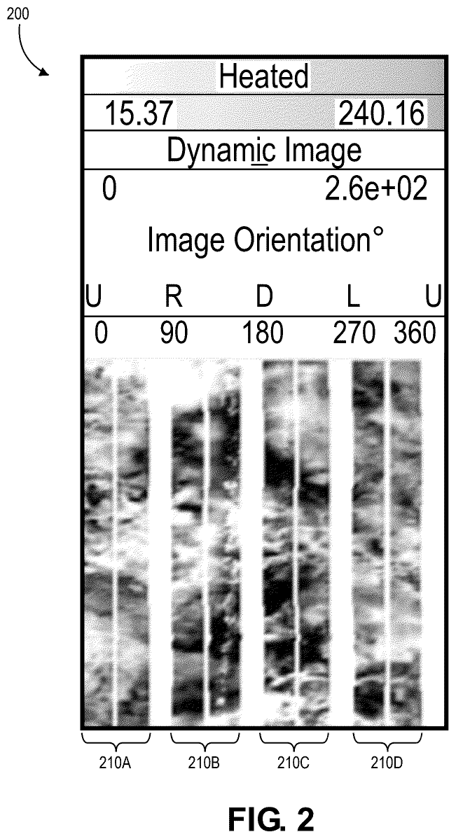

FIG. 2 illustrates a borehole image log 200 showing a vuggy carbonate interval, according to an embodiment. The borehole image 200 may be collected by a downhole tool during well logging. The downhole tool may include multiple arms, each having one or more electrodes. The white part or gap between images are gaps between the arms and the pads. Thus, there is no measurement in that area. The columns 210A-210D in the image log 200 that contain values are the logged parts. The columns shift is due to the rotation of the logging tool while acquiring the data. The borehole image 200 shows texture of the formation in the subsurface and resistivity properties. This data may be used to understand the structure and texture of the formation.

### Signal Description

Signal is another input in this workflow. The signal that is used in this workflow may be based on an openhole log (e.g., a mineralogical log). The signal may be used to define the lithology of the interval. Example signals may include:
WANH_INCP: Dry weight of anhydrite mineral
WCLA_INCP: Dry weight of clay mineral
WCLC_INCP: Dry weight of calcite mineral
WCOA_INCP: Dry weight of coal
WDOL_INCP: Dry weight of dolomite mineral
WEVA_INCP: Dry weight of evaporite mineral
WPYR_INCP: Dry weight of pyrite mineral
WQFM_INCP: Dry weight of quartz, feldspar and mica minerals
WRHD_INCP: Dry weight of rhodochrosite mineral
WSID_INCP: Dry weight of siderite mineral

### Preprocessing

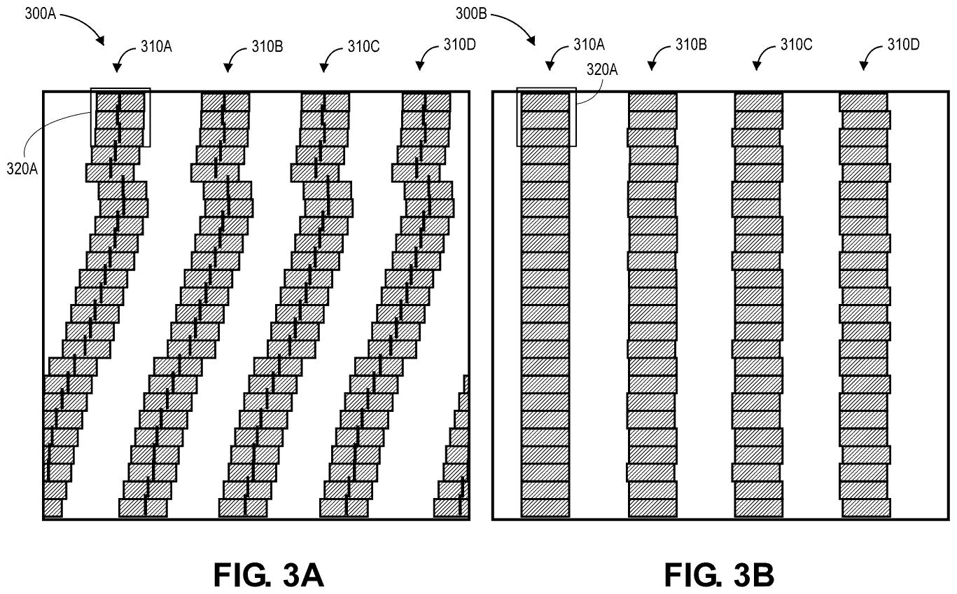

FIGS. 3A and 3B illustrate two borehole chunk images 300A, 300B corresponding to the original image (FIG. 3A) and the pre-processed image (FIG. 3B) by correcting the rotation and filling the gaps inside of the columns, according to an embodiment. The borehole image 300A may have 4 main columns 310A-310D which represent 360 degrees of tool viewing angles. A simple concatenation of the columns 310A-310D (e.g., by removing missing values) may not be suitable for this type of image 300 because the values are not continuous. Due to the tool movement and rotation, the 4 main columns 310A-310D may be separated into 5 by breaking one column into two (e.g., column 310A is broken into two). The processing step on columns 310A-310D is to separate the 4 main columns 310A-310D properly and re-organize the 5 columns scenario into 4 columns. This step may be performed with conventional coding.

Small chunks of missing value may be observed inside of the main columns. In an example, these small chunks may take 3 continuous pixels. The preprocessing step inside of columns is to apply linear interpolation to fill up the missing values.

Once the borehole image 300A has been arranged properly, the long image may be cut by the four main columns and by depth into square chunks 320A. In an example, the width of each main column 310A-310D may be 50 pixels, and the depth may be cut by 50 pixels. Due to major missing values between main columns 310A-310D, the chunks may be arranged into 4 layers type image. The borehole image chunk shape that is input to the neuron network may be 50*50*4.

In an example, ten signal channels may be identified to help identify the facies on the borehole image. The signals are simply concatenated into an image shape and cut with the same depth of borehole image chunks (e.g., 50 pixels). The shape of the signal chunks input to the neuron network may be 50*10*1.

### Modelling

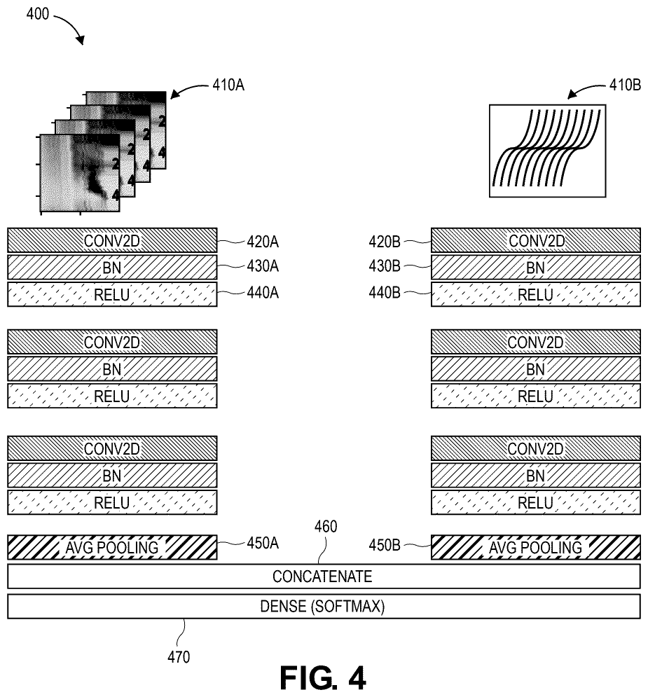

FIG. 4 illustrates a schematic view of the architecture of the convolutional neuron network (i.e., model) 400, according to an embodiment. The model may a two-headed convolutional neuron network 400. Both heads have the same architecture, but one receives borehole image chunks 410A, and the other receives signal chunks 410B.

### Convolutional Layer

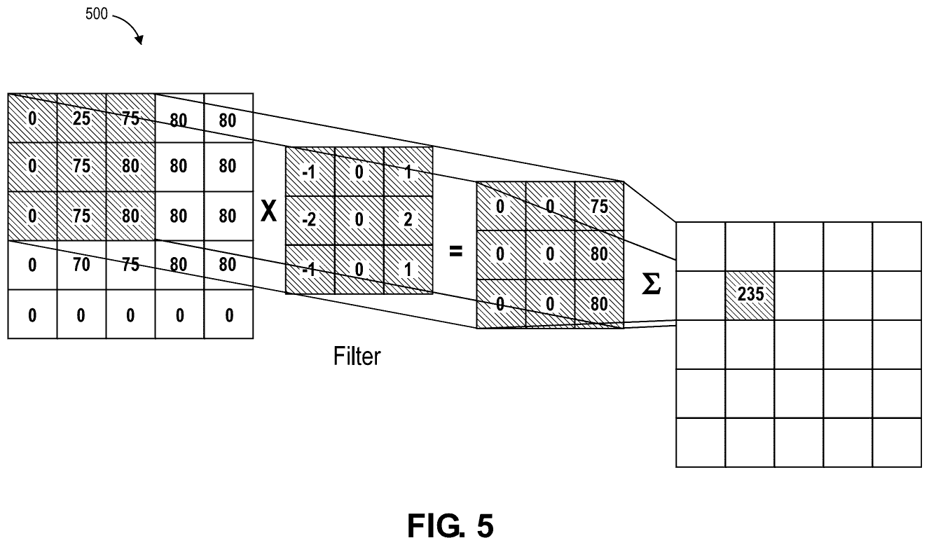

FIG. 5 illustrates a convolutional layer 500, according to an embodiment. A convolutional layer is a linear operation involving the multiplication of a set of weights with the input images represented by a matrix. The weights set is called a filter (with size of 3*3 in the image below) or kernel which is initialized with random values. The input in a convolutional layer may be an array with a shape: (number of inputs)×(input height)×(input width)×(input channels).
number of inputs: the number of images we feed to the network by batch
input height, the number of rows in the image
input width, the number of columns in the image
input channels, the borehole image chunks have 4 channels

Referring to FIGS. 4 and 5, an example, the initial Conv2D layer (CONV2D) 420A, 420B may utilize 64 filters, each of which produces a channel in the resulting feature map. These channels are subsequently concatenated in the output. The filters operate by scanning the image horizontally, and then computing a dot product between the pixel values of the image and the corresponding filter weights. This dot product involves element-wise multiplication of the filter weights with a segment of the input data, followed by summing the results into a single value. After passing through a convolutional layer, the image may be transformed into a more abstract representation known as a feature map.

The output of the convolutional layer 420A, 420B may be connected to the batch normalization layer (BN) 430A, 430B, which normalizes the data across the observations for each channel independently. This layer applies a transformation that ensures the mean output remains near 0 and the standard deviation is close to 1.

Then, a regular linear unit layer (RELU) 440A, 440B may be used. The RELU layer performs a threshold operation to each element of the input, where any value less than zero is set to zero. Finally, an average pooling layer (AVG POOLING) 450A, 450B reduces the data dimensions by aggregating the outputs of neuron clusters into a single neuron in the next layer using the average value. This process converts the feature map from the last block into a 1D series of length 64.

The two heads may be concatenated with a concatenation layer (CONCATENATE) 460. The concatenation layer concatenates the two 1D series horizontally to become one length of 128 vector. The softmax activation function (DENSE (SOFTMAX)) 470 then transforms this 128-length series into 16 classes (neurons), with the sum of the probabilities equal to 1.

### Exemplary Method

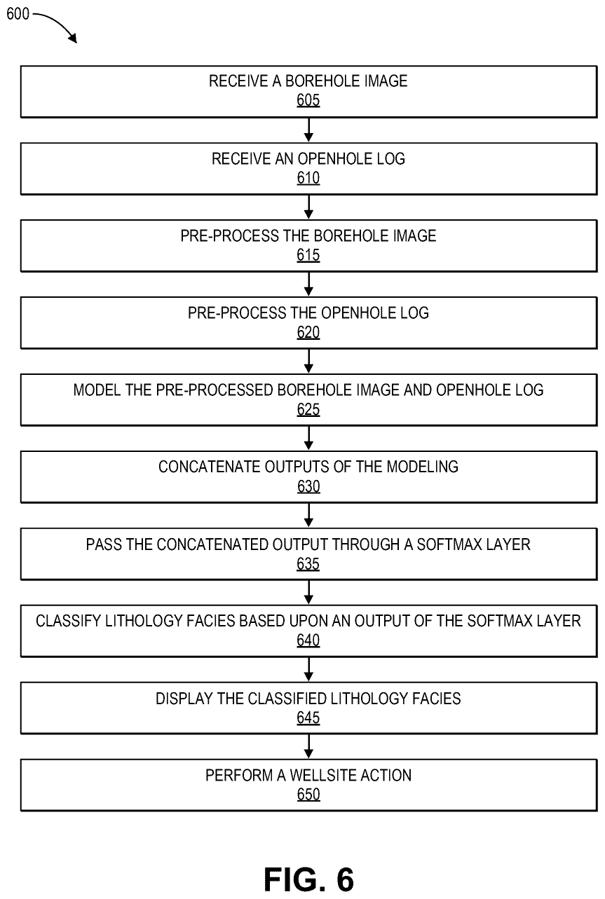

FIG. 6 illustrates a flowchart of a method 600 for classifying lithology facies, according to an embodiment. An illustrative order of the method 600 is provided below; however, one or more portions of the method 600 may be performed in a different order, simultaneously, repeated, or omitted. At least a portion of the method 600 may be performed with a computing system (described below).

The method 600 may include receiving a borehole image, as at 605. An example of this is shown in FIG. 2. The borehole image may be processed and interpreted. The borehole image shows a texture of a subsurface formation and resistivity properties in the subsurface formation. The borehole image may be captured during logging in a wellbore in the subsurface formation by a downhole tool with a plurality of arms and a plurality of electrodes.

The method 600 may also include receiving an openhole log, as at 610. The openhole log may be or include triple combo and/or spectroscopy data. The openhole log is configured to be used to define a lithology of one or more intervals in the subsurface formation.

The method 600 may also include pre-processing the borehole image to produce a pre-processed borehole image, as at 615. Pre-processing the borehole image may include vertically aligning columns in the borehole image. Vertically aligning the columns may include reducing a number of the columns in the borehole image. For example, the number may be reduced from a number of the arms plus one down to the number of arms (e.g., from 5 down to 4). Pre-processing the borehole image may also or instead include filling missing values inside the columns using interpolation. Pre-processing the borehole image may also or instead include cutting the columns by width and by depth into first square chunks. An example of this may be seen in FIG. 3B. Each first square chunk has a width that has a same number of pixels as a width of each of the columns (e.g., 50 pixels), and each first square chunk has a depth that has a same number of pixels as the depth of each of the columns (e.g., 50 pixels). Pre-processing the borehole image may also or instead include arranging the first square chunks such that a number of layers corresponds to a number of the columns, which causes a shape of the pre-processed borehole image to be 50*50*4.

The method 600 may also include pre-processing the openhole log to produce a pre-processed openhole log, as at 620. Pre-processing the openhole log may include concatenating the openhole log into an image shape. Pre-processing the openhole log may also or instead include cutting the image shape into second square chunks. Each second square chunk may have a width that has a same number of pixels as the width of each of the columns (e.g., 50 pixels), and each second square chunk may have a depth that has a same number of pixels as the depth of each of the columns (e.g., 50 pixels). In an example, a shape of the pre-processed openhole log may be 50*10*1.

The method 600 may also include modeling the pre-processed borehole image and the pre-processed openhole log to produce a first modelled output and a second modelled output, respectively, as at 625. The pre-processed borehole image may be modelled using a first head of a convolutional neuron network, and the pre-processed openhole log may be modelled using a second head of the convolutional neuron network. An example of this is shown in FIG. 4. Modeling the pre-processed borehole image and/or the pre-processed openhole log may include passing the pre-processed borehole image and/or the pre-processed openhole log through a convolutional layer of the convolutional neuron network to produce a convolutional layer output. An example of this is shown in FIG. 5. The modeling may also or instead include passing the convolutional layer output through a batch normalization layer of the convolutional neuron network to produce a batch normalization layer output. The modeling may also or instead include passing the batch normalization layer output through a regular linear unit layer of the convolutional neuron network to produce a regular linear unit layer output. The modeling may also or instead include aggregating the regular linear unit layer output from each of the iterations in an average pooling layer of the convolutional neuron network to produce the first modelled output and/or the second modelled output.

The method 600 may also include concatenating the first modelled output and the second modelled output from the first and second heads of the convolutional neuron network to produce a concatenated output, as at 630. The concatenated output may be a 1D series.

The method 600 may also include passing the concatenated output through a softmax layer, as at 635. Said another way, a softmax function may be applied to the concatenated output.

The method 600 may also include classifying lithology facies in the subsurface formation based at least partially upon an output of the softmax layer, as at 640.

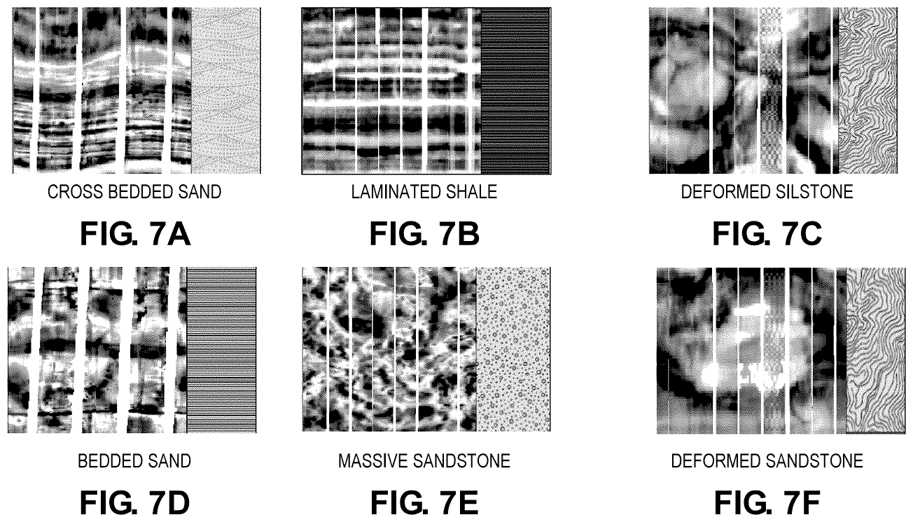

The method 600 may also include displaying the classified lithology facies, as at 645. FIGS. 7A-7F illustrate images of classified lithology facies, according to an embodiment. More particularly, FIG. 7A illustrates cross-bedded sand, FIG. 7B illustrates laminated shale, FIG. 7C illustrates deformed siltstone, FIG. 7D illustrates bedded sand, FIG. 7E illustrates massive sandstone, and FIG. 7F illustrates deformed sandstone.

The method 600 may also include performing a wellsite action, as at 650. The wellsite action may be based upon or in response to the classified lithology facies. The wellsite action may be or include generating and/or transmitting a signal (e.g., using a computing system) that recommends, instructs, or causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

In one example, the classified lithology facies may be or include vuggy carbonate facies. Vuggy carbonate refers to a type of carbonate rock that contains numerous cavities or voids known as vugs. Vuggy porosity is a relevant feature in carbonate reservoirs as it may influence the storage and flow capacity of hydrocarbons or other fluids within the rock. Thus, identifying the intervals with this facies from image log fast may help in optimizing the completion for the wellbore.

### Exemplary Computing System

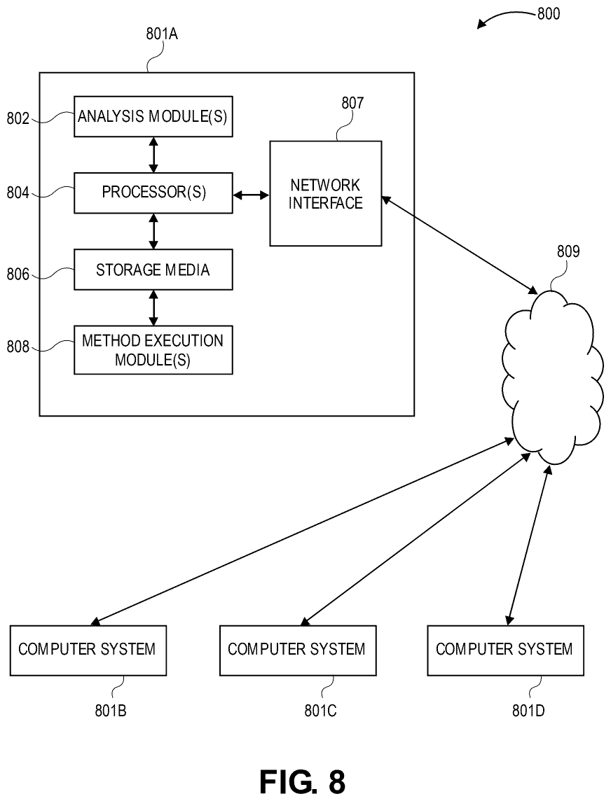

In some embodiments, the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor may include a microprocessor, microcontroller, processor module or subsystem, programmable integrated circuit, programmable gate array, or another control or computing device.

The storage media 806 may be implemented as one or more computer-readable or machine-readable storage media. Note that while in the example embodiment of FIG. 8 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 800 contains one or more method execution module(s) 808. In the example of computing system 800, computer system 801A includes the method execution module 808. In some embodiments, a single method execution module may be used to perform some aspects of one or more embodiments of the methods disclosed herein. In other embodiments, a plurality of method execution modules may be used to perform some aspects of methods herein.

It should be appreciated that computing system 800 is merely one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 800, FIG. 8), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for classifying lithology facies, the method comprising:
receiving a borehole image;
receiving an openhole log;
modeling the borehole image to produce a first modelled output;
modeling the openhole log to produce a second modelled output;
concatenating the first modelled output and the second modelled output to produce a concatenated output; and
classifying the lithology facies in a subsurface formation based at least partially upon the concatenated output.

2. The method of claim 1, wherein the borehole image is processed and interpreted, wherein the borehole image shows a texture of the subsurface formation and resistivity properties in the subsurface formation.

3. The method of claim 1, wherein the borehole image is captured during logging in a wellbore in the subsurface formation by a downhole tool with a plurality of arms, each having one or more electrodes.

4. The method of claim 1, wherein the openhole log comprises triple combo and/or spectroscopy data.

5. The method of claim 1, wherein the openhole log is configured to be used to define a lithology of one or more intervals in the subsurface formation.

6. The method of claim 1, wherein the borehole image is modelled using a first head of a convolutional neuron network, and wherein the openhole log is modelled using a second head of the convolutional neuron network.

7. The method of claim 6, wherein modeling the borehole image and/or the openhole log comprises iteratively:
passing the borehole image and/or the openhole log through a convolutional layer of the convolutional neuron network to produce a convolutional layer output;
passing the convolutional layer output through a batch normalization layer of the convolutional neuron network to produce a batch normalization layer output;
passing the batch normalization layer output through a regular linear unit layer of the convolutional neuron network to produce a regular linear unit layer output; and
aggregating the regular linear unit layer output from each of the iterations in an average pooling layer of the convolutional neuron network to produce the first modelled output and/or the second modelled output.

8. The method of claim 1, wherein the concatenated output comprises a 1D series.

9. The method of claim 1, further comprising displaying the classified lithology facies.

10. The method of claim 1, further comprising performing a wellsite action in response to the classified lithology facies.

11. A computing system, comprising:
one or more processors; and
a memory system comprising one or more non-transitory computer-readable media storing instructions that, when executed by at least one of the one or more processors, cause the computing system to perform operations, the operations comprising:
receiving a borehole image;
receiving an openhole log;
modeling the borehole image to produce a first modelled output;
modeling the openhole log to produce a second modelled output;
concatenating the first modelled output and the second modelled output to produce a concatenated output; and
classifying lithology facies in a subsurface formation based at least partially upon the concatenated output.

12. The computing system of claim 11, wherein the borehole image is captured during logging in a wellbore in the subsurface formation by a downhole tool with a plurality of arms, wherein pre-processing the borehole image comprises vertically aligning columns in the borehole image, wherein vertically aligning the columns comprises reducing a number of the columns in the borehole image, and wherein the number is reduced from a number of the arms plus one down to the number of arms.

13. The computing system of claim 12, wherein the operations further comprise pre-processing the borehole image to produce a pre-processed borehole image, and wherein pre-processing the borehole image further comprises filling missing values inside the columns using interpolation.

14. The computing system of claim 13, wherein pre-processing the borehole image further comprises cutting the columns by width and by depth into square chunks, wherein each square chunk has a width that has a same number of pixels as a width of each of the columns, and wherein each square chunk has a depth that has a same number of pixels as a depth of each of the columns.

15. The computing system of claim 14, wherein pre-processing the borehole image further comprises arranging the square chunks such that a number of layers corresponds to a number of the columns, which causes a shape of the pre-processed borehole image to be 50*50*4.

16. A non-transitory computer-readable medium storing instructions that, when executed by one or more processors of a computing system, cause the computing system to perform operations, the operations comprising:
receiving a borehole image;
receiving an openhole log;
modeling the borehole image to produce a first modelled output;
modeling the openhole log to produce a second modelled output;
concatenating the first modelled output and the second modelled output to produce a concatenated output; and
classifying lithology facies in a subsurface formation based at least partially upon the concatenated output.

17. The non-transitory computer-readable medium of claim 16, wherein the operations further comprise pre-processing the openhole log to produce a pre-processed openhole log, and wherein pre-processing the openhole log comprises concatenating the openhole log into an image shape.

18. The non-transitory computer-readable medium of claim 17, wherein pre-processing the openhole log further comprises cutting the image shape into square chunks.

19. The non-transitory computer-readable medium of claim 18, wherein each square chunk has a width that has a same number of pixels as a width of each column in the borehole image.

20. The non-transitory computer-readable medium of claim 19, wherein each square chunk has a depth that has a same number of pixels as a depth of each column in the borehole image such that a shape of the pre-processed openhole log is 50*10*1.
